(19) United States
(12) Patent Application Publication
(10) Pub. No.: US 2026/0055226 A1
(43) Pub. Date: Feb. 26, 2026

(54) THERMOPLASTIC POLYURETHANE, POLYURETHANE RESIN COMPOSITION COMPRISING THE SAME, AND MOLDED PRODUCT OBTAINED FROM THE SAME

(71) Applicant: BASF SE, Ludwigshafen am Rhein (DE)

(72) Inventor: Keisuke KANEDA, Lemfoerde (DE)

(73) Assignee: BASF SE, Ludwigshafen am Rhein (DE)

(21) Appl. No.: 19/128,599

(22) PCT Filed: Nov. 3, 2023
(86) PCT No.: PCT/EP2023/080687

§ 371 Date: May 9, 2025

(30) Foreign Application Priority Data
Nov. 11, 2022 (EP) 22206835.5

(51) Int. Cl. C08G 18/44; B29B 9/06; B29B 9/12; B29C 45/00; B29K 75/00; B29L 7/00; C08K 5/00

(52) U.S. Cl. CPC C08G 18/44; B29B 9/06; B29B 9/12; B29C 45/0001; C08K 5/005; B29K 2075/00; B29K 2995/0026; B29K 2995/007; B29L 2007/002

(57) ABSTRACT

A thermoplastic polyurethane as a product is disclosed which is obtained from a reaction mixture including (A) a polycarbonate polyol having a number-average-molecular weight Mn of greater than 500 and less than 2000, (B) an alicyclic polyisocyanate, and (C) a chain extender. The thermoplastic polyurethane has a hard segment (HIS) which occupies less than 40 mass %, based on the total mass of the thermoplastic polyurethane.

### TECHNICAL FIELD

The present invention relates to a thermoplastic polyurethane (TPU), a polyurethane resin composition comprising the TPU, and a molded product obtained from the polyurethane resin composition.

### BACKGROUND ART

Resin glasses have been widely used, for instance for windows of vehicles, which are light in weight and not easily broken, as a replacement of conventional silica-based glasses.

Such resin glasses are usually made of a plastic substrate such as polyacrylate or polycarbonate and a hard coat layer such as silica-based material or polymeric materials applied to the substrate. In other words, the plastic substrate is covered with the hard coat layer, for protecting the plastic substrate.

For instance, Japanese Patent 5944069 (Patent Literature 1) discloses a polymer substrate, in particular those having a good transparency to visible lights, covered with a silicon oxide layer as a hard coat layer. The silicon oxide layer is obtained by plasma-enhanced chemical vapor deposition (PE-CVD).

Further, Japanese Laid-Open Patent Application JP 2020-69749 A (Patent Literature 2) discloses a layered panel comprising a polycarbonate substrate and a thermoplastic elastomer such as polystyrene, polyurethane, polyester, polyamide or the like as a hard coat layer. In JP 2020-69749 A, it is recommended to further use a primer layer for improving the bond between the substrate and the hard coat layer.

In Japanese Patent 5944069, a silicon-based inorganic material is used as a hard coat layer, which has to be deposited onto a substrate by use of a special deposition facilities such as that for plasma-enhanced chemical vapor deposition.

On the other hand, JP-A 2020-69749 proposed to the use of a polymer film as a hard coat layer for a resin glass. According to JP-A 2020-69749, however, a primer has to be applied to a plastic substrate prior to the application of the hard coat layer made of the polymer, for maintaining the hard coat layer on the substrate.

### Technical Problem

However, the known materials do not necessarily have a good initial transparency, small initial haze, nor sufficient abrasion resistance, especially as a hard coat layer to be provided on a resin glass, particularly as a hard coat layer which satisfies ECE R43 standards regarding a glass component in a vehicle. Further, it is desirable if a resin or resin composition applicable as the hard coat layer can be manufactured economically, following a simple procedure.

It is therefore an object of the present invention to provide a thermoplastic polyurethane having a good transparency, low haze value, and good abrasion resistance, which can be readily applied as a hard coat layer on a polymer substrate. It is preferable that the application of the thermoplastic polyurethane to the substrate can be economically made.

### Solution to Problem

The inventor of the present inventor has found that the object of the invention is solved by:
a thermoplastic polyurethane as a product from a reaction mixture comprising:
   (A) a polycarbonate polyol having a number-average-molecular weight Mn of greater than 500 and less than 2000,
   (B) an alicyclic polyisocyanate, and
   (C) a chain extender, and
      wherein the thermoplastic polyurethane has a hard segment (HS) which occupies less than 40 mass %, based on the total mass of the thermoplastic polyurethane; or
a thermoplastic polyurethane as a product from a reaction mixture comprising:
   (A) a polycarbonate polyol having a number-average-molecular weight Mn of greater than 500 and less than 3000,
   (B) an alicyclic polyisocyanate, and
   (C) at least two kinds of chain extenders,
      wherein the thermoplastic polyurethane has a hard segment (HS) which occupies less than 50 mass %, based on the total mass of the thermoplastic polyurethane

### DESCRIPTION OF EMBODIMENT

### [Thermoplastic Polyurethane (TPU 1)]

A thermoplastic polyurethane (TPU1) of the present invention is a product from a reaction mixture (RM1) comprising:
(A1) a polycarbonate polyol having a number-average-molecular weight Mn of greater than 500 and less than 2000 (referred to as polyol (A1), or component (A1)),
(B1) an alicyclic polyisocyanate (referred to as polyisocyanate (B1) or component (B1)), and
(C1) a chain extender (referred to as chain extender (C1) or component (C1)).

In the thermoplastic polyurethane (TPU1) obtained from a reaction mixture (RM1) comprising polyol (A1), polyisocyanate (B1), and chain extender (C1), the hard segment (HS) occupies less than 40 mass % of the total mass of the thermoplastic polyurethane. The thermoplastic polyurethane has a hard segment (HS) and a soft segment (SS). The hard segment (HS1) as a cross-linking point in the TPU is prepared from the polyisocyanate (B1) and the chain extender (C1), and the soft segment (SS1) as a polymer matrix is prepared from the polyol (A1). The resultant TPU1 has a good initial transparency especially indicated by a low initial haze value, which can be maintained for a long period of time, having a good abrasion resistance.

The details of components (A1) to (C1) are as follows:

### [(A1) Polycarbonate Polyol]

Polycarbonate polyol (A1) is used for preparing the TPU1. Polyol (A) can be represented by following formula (I):

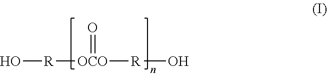

In formula (I), n is in the range of 1 to 100, preferably in the range of 2 to 20, and R is any one or more of straight chain alkylenes, preferably C₂-C₁₆ alkylene, more preferably C₃-C₁₂ alkylene, and more most preferably C₄-C₉ alkylene. For the preparation of TPU1, polycarbonate polyol (A1) is used which has a number-average molecular weight Mn in the range of greater than 500 and less than 2000, more preferably in the range of 600 to 1600, further preferably in the range of 750 to 1200.

A single kind or a combination or two or more kinds of polycarbonate polyols can be used as polyol (A1).

In the present invention, the number average molecular weight Mn is determined by:

$$Mn = ( 56100 \times valence ) / hydroxyl value .$$

In the above expression, the valence refers to the number of hydroxyl groups in a molecule. Then, the valence of polycarbonate diol in formula (1) is 2. Further, the hydroxyl value is measured according to JIS K 1557 (Method B).

### [Method for Producing a Polycarbonate Polyol]

Polyol (A1) of formula (I) can be produced by a reaction of alcohol component such as C₂-C₁₆ alkylene diol, preferably C₃-C₁₂ alkylene diol, and more preferably C₄-C₉ alkylene diol with a carbonate diester component such as carbonate dimethyl. In general, the alcohol component and the carbonate diester component which are substantially in an equimolar ratio are subjected to a transesterification reaction, usually in the presence of a catalyst.

The reaction temperature during the transesterification reaction is not particularly limited so far as a practical reaction rate can be obtained. The lower limit of the reaction temperature is usually 70° C., preferably 100° C., and more preferably 130° C. The upper limit of the reaction temperature is usually 250° C., preferably 200° C., more preferably 190° C., even more preferably 180° C., and particularly preferably 170° C. The reaction pressure at the completion of reaction is not particularly limited, but the upper limit at that point of time is usually 10 kPa, preferably 5 kPa, and more preferably 1 kPa.

The blending amount of polyol (A1) can be chosen in general from 40 to 75 parts by weight, and preferably from 50 to 75 parts by weight, based on 100 parts by weight of all components for the reaction to obtain thermoplastic polyurethane of the invention. In the present invention, the above-mentioned blending amount of polyol (A1) would not give any improper impact to haze value. Further, by use of polyol (A1) of the above-mentioned blending ratio, the cooling time of the TPU after injection molding can be shortened.

Polyol (A1) has a linear structure, that is a straight-chain structure without branches. However, a small amount, e.g., less than 5 wt. % based on entire amount of polyol (A1) of the other types of polyol such as branched polyol may be included in the formulation for preparing the TPU1. For such branched polyol, R in formula (I) may be C₃-C₁₄ alkylene with one or two C₁-C₃ alkyl side chains.

Based on the technical recognition, the good crystallinity is derived from a linear polyol. Therefore, it has been believed in prior art technologies, that a thermoplastic polyurethane prepared by use of a linear polyol, especially those with no branches is not recommended for obtaining a product with a good transparency. Contrary to such recognition, the use of polyol (A1), in the present invention, contributes to impart a good initial transparency and a small initial haze value to the TPU1.

### [(B1) Alicyclic Polyisocyanate]

As a component for TPU1, alicyclic polyisocyanate (B1) is used.

Examples of the alicyclic polyisocyanate (B1) includes alicyclic diisocyanate such as cyclohexane diisocyanate, dicyclohexyl methane diisocyanate isophorone diisocyanate (IPDI), 4,4′-dicyclohexyl methane diisocyanate (hydrogenated MDI), hydrogenated xylylene diisocyanate (hydrogenated XDI), and 1,4-bis(isocyanatomethyl)cyclohexane (1,4-H6XDI).

Among these, alicyclic diisocyanate having a completely or highly symmetric structure, such as 4,4′-dicyclohexyl methane diisocyanate, hydrogenated 1,4-xylylene diisocyanate, and 1,4-bis(isocyanatomethyl)cyclohexane are preferred. Primary isocyanates such as hydrogenated 1,4-xylylene diisocyanate and 1,4-bis(isocyanatomethyl)cyclohexane are particularly preferred.

A single kind, or two or more kinds of polyisocyanate can be used as polyisocyanate (B1) for preparing the thermoplastic polyurethane. In general, polyisocyanate (B1) is used in such an amount that can be completely or approximately equimolar NCO with respect to OH group in polyol (A1), regardless of the functionalities of polyol (A1) and polyisocyanate (B1).

The concentration of the alicyclic polyisocyanate (B1) can be appropriately in the range of 1.1 to 1.8 mol/kg, preferably in the range of 1.2 to 1.8, based on the total mass of components (A1) to (C1).

### [(C1) Chain Extender]

As a component for TPU1, a chain extender (C1) is used, which is at least one selected from a group consisting of 1,2-ethanediol, 1,3-propanediol (1,3-PD), 1,4-butanediol (1,4-BD), 1,5-pentanediol, 1,6-hexanediol (1,6-HD), 1,7-heptanediol, 1,8-octanediol, 1,9-nonanediol (1,9-ND), 3-methyl-1,5-pentanediol, 2-methyl-1,8-octanediol, diethylene glycol and dipropylene glycol.

In other words, a single kind or a combination or two or more kinds of the above diols can be used as the chain extender (C1).

A single use of 1,4-butanediol is preferred. Further, a combined use of 1,4-butanediol and another one or more of 1,3-propanediol, 1,4-butanediol, 1,5-pentanediol, 1,9-nonanediol (1,9-ND) is also preferred. Especially by the combined use, initial haze and abrasion resistance of the TPU tend to be improved.

### [Hard Segment (HS1)]

The TPU1 of the present invention has less than 40 mass % of hard segment (HS1), preferably 10 to 35 mass %, in particular 15 to 30 mass %, with respect to the total mass of TPU1. When the hard segment (HS1) is less than 40 mass %, TPU1 with a good abrasion resistance is obtained. Within the above numerical ranges, not only abrasion resistance of TPU1, but also resistance to chemicals and antifouling performance are improved. Further, a good process performance, especially for moldability and film-forming properties can be obtained when HS1 is set as stated above.

The content of the hard segment can be controlled, in accordance with a known method, to the above range by appropriately choosing the blending amount of the components in the reaction mixture (RM1). More specifically, the weight ratio of polyol (A1) and polyisocyanate (B1) can be in the range of (10:10) to (10:2), preferably in the range of (10:9) to (10:3) and in particular (10:7) to (10:5) ((A1):(B1)). Simultaneously, the weight ratio of polyisocyanate (B1) and chain extender (C1) can be in the range of (1:1) to (6:1), preferably in the range of (1:1) to (5:1), and in particular (1.5:1) to (3.5:1) ((B1):(C1)).

Another type of thermoplastic polyurethane (TPU2) is as good as TPU1 for the optical properties (initial transparency, initial Haze) and mechanical strength (abrasion resistance).

### [Thermoplastic Polyurethane (TPU 2)]

A thermoplastic polyurethane (TPU2) of the present invention is a product from a reaction mixture (RM2) comprising:
(A2) a polycarbonate polyol having a number-average-molecular weight Mn of greater than 500 and less than 3000 (referred to as polyol (A2) or component (A2)),
(B2) an alicyclic polyisocyanate (referred to as polyisocyanate (B2) or component (B2)), and
(C2) at least two kinds of chain extenders (referred to as chain extender (C1) or component (C1)).

For preparing TPU2, two or more kinds of chain extenders are required in the reaction mixture (RM2) comprising components (A2) to (C2).

The thermoplastic polyurethane (TPU2) is obtained from a reaction mixture (RM2) comprising polyol (A2), polyisocyanate (B2), and chain extender (C2), wherein the TPU2 occupies less than 50 mass % based on the total mass of the thermoplastic polyurethane (TPU 2). The thermoplastic polyurethane has a hard segment (HS) and a soft segment (SS). The hard segment (HS2) as a crosslinking point in the TPU is prepared from the polyisocyanate (C2) and the chain extender (B2), and the soft segment (SS2) as a polymer matrix is prepared from the polyol (A1). The resultant TPU2 has a good initial transparency especially indicated by a low initial haze value, which can be maintained for a long period of time, having a good abrasion resistance.

### [(A2) Polycarbonate Polyol]

As for polycarbonate polyol (A2) used for preparing the TPU2, the same materials as those for polyol (A1) can be used, except that the number-average-molecular weight Mn of polyol (A2) can be in the range of greater than 500 and less than 3000. The other details including the determination of number average molecular weight Mn and the example of the production of polyol (A2) are also same as those described for polyol (A1).

### [(B2) Alicyclic Polyisocyanate]

Alicyclic polyisocyanate (B1) which can be used for TPU1 is also used as alicyclic polyisocyanate (B2).

### [(C2) Chain Extenders]

As a further component for TPU2, at least two kinds of chain extenders (C2) are used, which are selected from a group consisting of 1,2-ethanediol, 1,3-propanediol, 1,4-butanediol, 1,5-pentanediol, 1,6-hexanediol, 1,7-heptanediol, 1,8-octanediol, 1,9-nonanediol, 3-methyl-1,5-pentanediol, 2-methyl-1,8-octanediol, diethylene glycol and dipropylene glycol.

A combined use of a smaller chain extender such as 1,2-ethanediol or 1,3-propanediol (smaller CE) with one or more larger chain extender selected from 1,2-ethanediol, 1,3-propanediol, 1,4-butanediol, 1,5-pentanediol, 1,6-hexanediol, 1,7-heptanediol, 1,8-octanediol, 1,9-nonanediol, 3-methyl-1,5-pentanediol, and 2-methyl-1,8-octanediol, diethylene glycol and dipropylene glycol (larger CE) is preferred. It is further preferable that blending ratio of smaller CE and larger CE is in the range of (3:97) to (60:40), in particular in the range of (5:95) to (30:70).

### [Hard Segment (HS2)]

The TPU1 of the present invention has less than 50 mass % % of hard segment (HS1), preferably 10 to 40 mass %, in particular 15 to 35 mass %, with respect to the total mass of TPU2. When the hard segment (HS2) is less than 50 mass %, TPU2 with a good abrasion resistance is obtained. Within the above numerical ranges, not only abrasion resistance of TPU2, but also resistance to chemicals and antifouling performance are improved. Further, a good process performance, especially for moldability and film-forming properties can be obtained when HS2 is set as stated above.

In the TPU (TPU1 or TPU2) of the present invention, the content of HS (HS1 or HS2) in the TPU is set by choosing the amount of to have the above-mentioned ranges by choosing the amount of polyol (A), isocyanate (B) and chain extender (C) so as to satisfy the following formula:

$$Content of HS : \text{} \{ ( mole of isocyanate ( B ) - mole of OH end group of polyol ( A ) ) * ( mass of isocyanate ( B ) ) + ( mass of chain extender ( C ) \} / ( mass of isocyanate ( B ) ) + mass of chain extender \text{} ( C ) + mass of polyol ( A ) ) \times 100$$

In other words, the content of the hard segment can be controlled, in accordance with a known method, to the above range by appropriately choosing the blending amount of the components in the reaction mixture (RM2). More specifically, the weight ratio of polyol (A2) and polyisocyanate (B2) can be in the range of (10:10) to (10:2), preferably in the range of (10:8) to (10:4) and in particular (10:7) to (10:5 ((A2):(B2)). Simultaneously, the weight ratio of polyisocyanate (B2) and chain extender (C2) can be in the range of (1:1) to (6:1), preferably in the range of (1:1) to (4:1), and in particular (1.5:1) to (2.5:1) ((B2):(C2)).

The thermoplastic polyurethanes, i.e., both TPU1 and TPU2 of the invention, regardless of the slight difference in formulations therebetween, have excellent optical properties. In the present invention, the samples of the TPU or TPU composition soon after preparation, cooled to room temperature (25° C.) under atmospheric pressure and left as they are at most for 88 hours having the same state maintained without exposure to outdoor condition are referred to as “initial-state sample”. The total transparency and haze value of the initial state sample are referred to as initial total transparency (TT) and initial haze. The TPU and TPU composition of the invention have excellent initial total transparency (TT)) and small initial haze value. Further, the thermoplastic polyurethanes of the invention have good mechanical properties such as ade-quate hardness for protecting the surface of a plastic substrate as a part of a resin glass, and improved abrasion resistance. Accordingly, the thermoplastic polyurethane well maintains the initial transparency and initially obtained low haze value even after being exposed to a severe environmental condition because of a good abrasion resistance.

### [Manufacture of Thermoplastic Polyurethane (TPU)]

The thermoplastic polyurethane can be synthesized in accordance with known methods, by using the above components (A) to (C) as raw materials, optionally with a catalyst, a cross-linking agent, a cross-linking aid or the like. Polyurethane may be produced in batches or continuously, both of which are carried out by known methods.

In the continuous method, polyurethane is produced, for example by use of a reaction extruder(s), in accordance with a one-shot method, a prepolymer method or the like. In general, the one-shot method is preferably used with the production cost and time taken into account. On the other hand, a semi-prepolymer method and a prepolymer method may also be used in order to proceed with a reaction to obtain products with uniform qualities and improved transparency. In these methods, in general, the components (A) to (C) are mixed continuously, and react with each other immediately after being mixed, in general. When an extruder such as a twin-screw extruder is used, the components (A) to (C), and additionally a catalyst and/or a further material, if any, are loaded into an extruder, individually or in the form of a preliminarily mixed state. The temperature of an extruder can be increased to 120-240° C., preferably 150-220° C. Thereafter, the resultant polyurethane is extruded, followed by being cooled and pelletized.

From the view-points of durability and moldability, it is preferable that the thermoplastic polyurethane has a weight-average molecular weight Mw in the range of preferably 80,000 to 250,000, more preferably 100,000 to 150,000. The molecular weight can generally be controlled by adjusting the ratio of the molar amount of OH-carrying component (sum of polyol and chain extenders) to the molar amount of polyisocyanate component. The molecular weight can also be controlled by adding monool (mono alcohol) such as methanol, ethanol, propanol, butanol, 2-ethylhexyl alcohol to the reaction system.

The molecular weight of polyurethane is determined with GPC method (gel permeation chromatography), using polystyrene as a standard polymer, THF as an eluent, the sample solution being prepared to have a concentration of about 0.1%. The determination was made by use of HLC-8220 GPC manufactured by Tosoh Corporation, e.g., having a flow rate of 0.35 ml/min, and temperature of 40° C., over the measurement time of 15 minutes. The same applies to the Examples described below.

As described above, the polyurethane according to the present invention can be prepared, in the first place, generally in the form of pellets, but may be in the form of powder. Subsequently, TPU processing may be further carried out by a known method such as injection molding, calendaring or extruding. Especially for forming a TPU sheet as a hard coat application on a resin substrate, a twin-screw extruder is preferably used.

Further materials such as catalysts, cross-linking agents, and cross-linking aids can be used in the production of the polyurethane according to the present invention. Types of the applicable materials are not particularly limited so far as the object of the present invention can be achieved.

Specific examples of the catalysts include tin-containing organometallic compounds, for example, dibutyl tin dilaurate (DBTDL), dioctyl tin dilaurate, dibutyl tin diacetate, tin (II) bis(2-ethylhexanoate); titanic acid esters; zirconium compounds; bismuth-containing organometallic compounds, for example, bismuth carboxylates including bismuth (III) neodecanoate and bismuth (III) 2-ethylhexanoate; iron-containing organometallic compounds; amine-based catalysts, for example, triethylamine, triethylenediamine, N-methylimidazole, N-ethylmorpholine, 1,8-diazabicyclo[5,4,0]-7-undecene (DBU)); potassium acetate; phosphorus compounds, for example, tributylphosphine, phosphorene and phosphorene oxide. These can be used alone or in combination of two or more.

The total amount of the catalyst to be used is preferably 5% by mass or less, more preferably in a range of 0.001% by mass to 2% by mass, based on the total mass of the components (A) to (C).

The thermoplastic polyurethane according to the present invention can be subjected to moldings, without further use of additives or the like. The resultant formed product exhibits excellent transparency and abrasion resistance. Still, it is possible to further add additives to the TPU, if any modification becomes necessary.

In the present invention, total light transmittance (Tt) according to JIS K 7361-1:1997 and haze according to JIS K 7136:2000 are used for evaluating the transparency.

### [Thermoplastic Polyurethane Composition]

As mentioned above, it is possible to add one or more additives even to the completed TPU. Examples of such additives include antioxidants, light stabilizers, UV absorbers, nucleating agents, surface modifiers, optical brighteners, lubricants, anti-hydrolysis agents, crosslinkers, antistatic agents, anti-blocking agents, heat stabilizers, flame retardants, heat resistance improvers, weather resistance improvers, reaction retarders, plasticizers, conductivity imparting agents, antibacterial agents, antifungal agents, inorganic and organic fillers, fiber-based reinforcements and colorants. Thermoplastic polyurethane compositions with variety of properties can be obtained depending upon the application or intended use, by use of the above additives.

As additives for imparting weather resistance, antioxidants, light stabilizers, ultraviolet inhibitors, or a combination of two or more of those may be added to the polyurethane, depending on the intended use of the polyurethane composition.

Antioxidants are preferably added to the polyurethane or polyurethane composition when a molded product therefrom is to be exposed to outdoor use, other environmental conditions where an oxidative deterioration is anticipated. The type of antioxidants is not particularly limited, and known materials can be used.

In addition, phosphorus-based antioxidants (for example, tris(2,4-di-tert-butylphenyl)phosphite (Irgafos (Trademark) 168, manufactured by BASF Japan Ltd.), vitamin E-based antioxidants (for example, 3,4-dihydro-2,5,7,8-tetramethyl-2-(4,8,12-trimethyltridecyl)-2H-benzopyran-6-ol (Irganox (Trademark) E 201, BASF Japan Ltd.)) can also be used.

The use of amine-based antioxidants is not preferred, when the polyurethane or polyurethane composition should not be colored.

It is possible to use the antioxidants in an amount of 0.01 to 2% by mass, preferably 0.1 to 1% by mass, particularly 0.1 to 0.5% by mass, based on the total mass of the thermoplastic polyurethane.

Further, ultraviolet absorbers may be added to the polyurethane composition as discussed above. The type of the ultraviolet absorber is not particularly limited, and known material can be used. Specific examples of the ultraviolet absorbers include cinnamic ester, diphenyl cyanoacrylate, formamidine, benzylidene malonate, diarylbutadiene, triazine-based and benzotriazole-based UV absorbers (for example, Tinuvin (Trademark) 329, manufactured by BASF Japan Ltd.).

As described above, the polyurethane according to the present invention exhibits excellent transparency with a low haze which can be maintained for a long time even without relying on ultraviolet absorbers. Therefore, ultraviolet absorbers are not usually added to the polyurethane. In contrast, ultraviolet absorbers are preferably used when a molded product is constantly exposed to strong ultraviolet rays, such as that for outdoor installation.

Likewise, a light stabilizer may be added to the polyurethane according to the present invention, as discussed above. The type of light stabilizer is not particularly limited, and known materials can be used. A hindered amine light stabilizer (HALS) may be used as the light stabilizer. Examples of the HALS stabilizers as commercially available products are described in the “Plastic Additives Handbook” (5th Edition, H. Zweifel, Hanser Publishing Co., Munich, 2001, pp. 123-136). The hindered amine light stabilizer has a number-average molecular weight of preferably 500 g/mol to 10000 g/mol, more preferably 1000 to 5000 g/mol. Particularly preferrable hindered amine photostabilizers are bis(1,2,2,6,6-pentamethyl piperidyl) sebacate (Tinuvin (Trademark) 765, manufactured by BASF Japan Ltd.), a condensation product of 1-hydroxyethyl-2,2,6,6-Tetramethyl-4-hydroxypiperidine and succinic acid (Tinuvin (Trademark) 622, manufactured by BASF Japan Ltd.), polymer sterically hindered amine (Chisorb (Trademark) 622LT, Double Bond Chemical Ind., Co., Ltd.). A condensation product of 1-hydroxyethyl-2,2,6,6-tetramethyl-4-hydroxypiperidine and succinic acid (Tinuvin (Trademark) 622) is particularly preferably used. The concentration of HALS compound used is preferably 0.01 to 3% by mass, more preferably 0.1 to 2.0% by mass, and even more preferably 0.1 to 1.0% by mass, based on the mass of polyurethane.

Further, nucleating agents can be added to the polyurethane according to the present invention. The type of the nucleating agents is not particularly limited. Known nucleating agents can be used. Specific examples include dibenzylidene sorbitol-based nuclear agent (for example, Millad (Trademark) NX8000 manufactured by Milliken Chemical Co. Ltd.), benzoic acid metal salt-based nucleating agent, a phosphate ester salt-based nucleating agent, and a rosin-based nucleating agent. The blending ratio of nucleating agents can be 0.3% by mass or less, more preferably 0.1 to 0.25% by mass, based on the mass of polyurethane. When the amount of the nucleating agent to be added is 0.3% by mass or less, the resultant polyurethane molded product becomes excellent in terms of haze value and yellowing resistance.

A surface modifier can be used as a further additive in the polyurethane according to the present invention. The type of the surface modifier is not particularly limited. Known surface modifiers such as wax or lubricant can be used. Specific examples include petroleum-derived hydrocarbon waxes, for example, ozokerite, paraffin wax, montanic acid ester wax, animal wax such as bees wax, shellac wax, wool wax, or vegetable wax such as carnauba wax, candelilla wax, rice wax, fatty acid amide wax such as ethylene bis stearamide (EBS), N,N′-ethylene bis oleamide (EBO), or erucamide, polyolefin wax such as polyethylene wax, polypropylene wax, Fischer-Tropsch wax, polyethylene oxide wax and modified-polyolefin waxes such as graft- or copolymer-type polyolefin. In addition, acrylic polymer lubricants (for example, Metabrene L1000 manufactured by Mitsubishi Chemical Corporation) can be used as surface modifiers. In the present invention, a montanic acid ester wax (for example, Licolub WE4 manufactured by Clariant Japan Co., Ltd.) and an acrylic polymer lubricant are particularly preferably used. As a result, the product molded from the polyurethane will have improved lubricating property and a good mold releasability. Further, bleeding-out phenomenon over time can be restricted by adjusting the amount of the additives.

As described above, a surface modifier can be added alone or in combination of two or more types. The amount of the surface modifier can be 0.01 to 1% by mass, preferably 0.01 to 0.5% by mass, based on the mass of the polyurethane.

Known colorants can be added to the polyurethane composition according to the present invention. The types thereof are not particularly limited. A blue pigment can also be used as bluing agent in order to reduce initial yellowness. In addition, appearance of the polyurethane composition can be further improved by the joint use of a fluorescent whitening agent.

### [Preparation of Polyurethane Composition (TPU Composition)]

For preparing a TPU composition, i.e., a mixture of the above-mentioned TPU and additional component(s), a predetermined amount of one or more additives are appropriately metered into the TPU, followed by mixing by the aid of a known blending device and installation including a kneader and a mixer. The TPU is generally processed into the form of pellets or powders in accordance with a known method such as injection molding, calendaring, or extrusion. For example, TPU is supplied into a post-extruder, and then usually kneaded and melted at a temperature of about 150 to 230° C. in an ambient atmosphere. Thereafter, TPU is extruded into a desired shape. A twin-screw mixer, a continuous single-screw or twin-screw mixer including a continuous kneading extruder can be used.

The TPU composition may be in the form of powder, flakes, rods, sheets, or blocks, or alternatively in the form of pellets or granules through e.g., strand cutting or underwater cutting.

### [Manufacturing of Molded Products]

The thus obtained (TP composition is molded into a product with a desired shape, for example, by using a suitable molding device or a mold. A known molding devices or molds can be appropriately used so far as the polyurethane composition can be molded into a desired shape.

The application of the molded product obtained from the TPU composition is not particularly limited. Having excellent transparency which can be well maintained even after being exposed to environmental stress for a long time, as well as a good hardness, the TPU of the invention, for example, is applicable as a hard coat film for windows especially for vehicles or buildings. Further application of the TPU of the invention includes molded articles such as external parts of automobiles, motorcycles, bicycles, ships, trains, or planes.

### [Substrate]

The TPU as it is or TPU composition of the invention can be applied to a substrate, for example as a hard coat film on the substrate. Examples of the substrate include a resin such as a polycarbonate resin, a polymethyl methacrylate resin, a methyl methacrylate resin, a transparent acrylonitrile butadiene styrene resin, a transparent polystyrene resin, a transparent epoxy resin, a polyarylate, a polysulfone, a polyethersulfone, a transparent nylon resin, a transparent polybutylene terephthalate, a transparent fluororesin, poly-4-methylpentene-1, a transparent phenoxy resin, a polyimide resin and a transparent phenol resin.

The present invention will now be explained with reference to Examples, to which present invention is not limited. Unless otherwise specified, “parts” and “%” are based on mass.

### EXAMPLES

### Examples 1-1 to 1-9 and 2-1 to 2-3, and Comparative Examples 2-1 to 2-5 and 2-1 to 2-4

### <TPU Synthesis>

The following operations were carried out, for the Examples and the Comparative Examples, by use of the materials listed in Table 1 in the amounts shown therein.

Polyol (A) and chain extender (C)) were metered into a cylindrical 2 L size metal container and a temperature in the range of 90 to 95° C. An antioxidant, a light stabilizer, a UV absorber, a lubricant, a nucleating agent, and a catalyst were added and stirred at 200-300 rpm until the mixture was uniformly mixed. Then, polyisocyanate (B) preliminarily heated at 50° C. was loaded in the container, and the mixture was continued to be stirred until the temperature reached 105° C.

After reaching 105° C., the thus obtained liquid mixture was transferred to a Teflon (Trademark) container and then annealed at 95° C. for 15 hours to increase the molecular weight into a polymer. Accordingly, the TPU resin in the form of a slab was obtained. The slab was cut and pulverized to form flakes.

The flakes were fed into a twin-screw extruder (manufactured by WERNER & PFLEIDERER, ZSK30:30 mmφ) from a feeder. The temperature in the region from a hopper to a die head was set to be 180-210° C. The flakes were melted and kneaded simultaneously with being extruded in the form of strands, while the screw was rotating at a rotation speed of 100 to 110 rpm. The strands were brought in a water tank, cooled therein, and then cut with a pelletizer to continuously obtain a uniformly made pellet-shaped TPU composition.

### <Molding of Test Samples>

The above TPU composition was subjected to injection-molding by using an injection molding machine (TM130F2: manufactured by Toyo Machinery & Metal Co., Ltd.) under the following conditions. As for the molding temperature, the nozzle tip of the injection molding machine was set to have a temperature in the range of 200 to 210° C. The temperatures of the cylinders were sequentially lowered by 5° C., toward hopper side. The temperature of the lower part of the hopper was set to be 180 to 190° C. The mold temperature was set at 25° C.

The TPU composition was heated and melted, and then injected by use of a 40 mm q screw, at an injection speed: 10% (11 mm/sec), and at an injection pressure: 90 kgf/(1130 kgf/cm²). After holding the pressure of 80 kgf/(1070 kgf/cm²) for 40 seconds to cool the mold, a plate-shaped molded product of 160 mm (length)×105 mm (width)×2 mm (thickness) was obtained. All test samples were found to have excellent surface smoothness with no dents or scratches thereon. These samples were used for evaluating Shore A hardness. The same samples were also used to evaluate optical properties.

The test samples were found to have excellent surface smoothness with no dents or scratches thereon. Herein, test samples after cooled to 25° C. under atmospheric pressure kept to have the same condition for 88 hours (initial-state sample) were used for following tests.

### <Determination of HS Content (%)>

The hard segment (HS) in the initial-state samples were set to have the values described in Table 1 by metering polyol (A), isocyanate (B) and chain extender (C) so as to satisfy the following equation:

$$Content of HS : \text{} \{ ( mole of isocyanate ( B ) - mole of OH end group of polyol ( A ) ) * ( mass of isocyanate ( B ) ) + ( mass of chain extender ( C ) \} / ( mass of isocyanate ( B ) ) + mass of chain extender \text{} ( C ) + mass of polyol ( A ) ) \times 100$$

### [Evaluation of Optical Properties]

### <Evaluation of Total Light Transmittance (TT)>

The total light transmittance of the initial-state sample was evaluated according to JIS K 7361-1:1997. The obtained values were described in Table 1 as initial total light transmittance, i.e., “Initial TT”.

### <Evaluation of Initial Haze>

The haze value of the initial-state sample was evaluated according to JIS K 7136:2000, and the measured values were described in Table 1, as “Initial Haze”.

In general, the transparency of the sample is affected by haze. Generally speaking, samples having initial total light transmittance of 85% or more and initial haze of 10% or less are acceptable for products requiring transparency.

Good transparency is perceived when the initial total light transmittance is 85% or more, especially 90% or more, and particularly 95 or more, and the initial haze is 5% or less, especially 3.5 or less, and particularly 3.0 or less. The above-mentioned initial haze values are applicable when the initial state sample has a thickness of 2 mm or less, in particular 150 μm or less.

<Evaluation of Difference in Haze Value after Taber Abrasion Test>

For evaluating the abrasion resistance of the sample, the samples were subjected to Taber abrasion test for 500 revolutions in accordance with ASTM D1044 (Taber 500). The haze values of the samples after the Taber abrasion test were measured in according to JIS K 7136:2000. The difference (%) in haze value (Δ Haze) of the sample after the Taber abrasion test from the Initial haze was obtained:

$$Δ Haze ( \% ) = Haze ( \% ) of sample after Taber 500 - Initial Haze ( \% )$$

The results were shown in Table 1 as “Taber 500 (Δ Haze)”. Needless to say, the lower the value as Δ Haze, the better the abrasion resistance.

### [Evaluation of Mechanical Properties]

### <Evaluation of Shore a Hardness>

The test samples were subjected to the measurements according to JIS K 7311-1995 for determining shore A hardness. Shore A hardness was measured by use of 3 stacked test samples to have a total thickness of 6 mm for each of the Examples and Comparative Examples, by use of type A durometer. The evaluation results are shown in Table 1.

TABLE 1
Table 1

| | (A) Polycarbononate Polyol | | | | | | | (C) Chain Extender | | | | | | | Taber |
|---|---|---|---|---|---|---|---|---|---|---|---|---|---|---|---|
| | Mn = | Mn = | Mn = | Mn = | Average | | | 1,3- | 1,4- | 1,9- | | Hard- | Ini- | Ini- | 500 |
| | 500 | 1000 | 2000 | 3000 | Morecular- | (B) H6XDI | | PD | BD | ND | | ness | tial | tial | (Δ |
| | (g/ | (g/ | (g/ | (g/ | Weight | (g/ | (mol/ | (g/ | (g/ | (g/ | HS | A | TT | Haze | Haze) |
| Examples | kg) | kg) | kg) | kg) | (Mn) | kg) | kg) | kg) | kg) | kg) | (%) | (Point) | (%) | (%) | (%) |
| Example 1-1 | 477.44 | 0 | 0 | 119.36 | 600 | 336.58 | 1.735 | 0 | 66.61 | 0 | 21 | 97 | 90.17 | 3.2 | 5.7 |
| Example 1-2 | 376.52 | 0 | 0 | 251.01 | 750 | 305.86 | 1.577 | 0 | 66.61 | 0 | 21 | 96 | 90.9 | 1.7 | 4.8 |
| Example 1-3 | 264.63 | 0 | 0 | 396.95 | 1000 | 271.81 | 1.401 | 0 | 66.61 | 0 | 21 | 95 | 91 | 1.6 | 2.9 |
| Example 1-4 | 204.01 | 0 | 0 | 476.03 | 1200 | 253.35 | 1.306 | 0 | 66.61 | 0 | 21 | 94 | 90.9 | 1.7 | 2.7 |
| Example 1-5 | 219.51 | 0 | 0 | 512.18 | 1200 | 220.74 | 1.138 | 0 | 47.58 | 0 | 15 | 90 | 92.4 | 2.2 | 1.8 |
| Example 1-6 | 180.77 | 0 | 0 | 421.8 | 1200 | 302.28 | 1.558 | 0 | 95.16 | 0 | 30 | 98 | 87.8 | 4.1 | 5.2 |
| Example 1-7 | 139.91 | 0 | 0 | 559.64 | 1500 | 233.84 | 1.205 | 0 | 66.61 | 0 | 21 | 94 | 91.2 | 3.4 | 1.5 |
| Example 1-8 | 376.52 | 0 | 0 | 251.01 | 750 | 307.5 | 1.584 | 12.99 | 51.98 | 0 | 21 | 96 | 90.5 | 2.4 | 3.7 |
| Example 1-9 | 204.01 | 0 | 0 | 476.03 | 1200 | 254.99 | 1.314 | 12.99 | 51.98 | 0 | 21 | 92 | 90.9 | 1.5 | 1.3 |
| Comp. Ex. 1-1 | 568.95 | 0 | 0 | 0 | 500 | 366.07 | 1.886 | 12.99 | 51.98 | 0 | 21 | 98 | 84.4 | 7.3 | 9.4 |
| Comp. Ex. 1-2 | 0 | 0 | 499.87 | 0 | 2000 | 357.39 | 1.842 | 0 | 142.74 | 0 | 45 | 98 | 86.1 | 6.4 | 38 |
| Comp. Ex. 1-3 | 0 | 0 | 0 | 742.14 | 3000 | 191.25 | 0.986 | 0 | 66.61 | 0 | 21 | 88 | 86.9 | 4.5 | 1.4 |
| Example 2-1 | 0 | 401.68 | 201.44 | 0 | 1200 | 265.15 | 1.367 | 6.59 | | 125.14 | 30 | 95 | 86.2 | 3.3 | 5.1 |
| Example 2-2 | 0 | 172.29 | 343.55 | 0 | 1200 | 313.55 | 1.616 | 17.06 | | 153.55 | 40 | 97 | 85.2 | 3.3 | 8.2 |
| Example 2-3 | 0 | 172.29 | 343.55 | 0 | 1200 | 318.28 | 1.641 | 24.88 | | 141.00 | 40 | 97 | 85.0 | 3.4 | 6.8 |
| Example 2-4 | 0 | 172.29 | 343.55 | 0 | 1200 | 327.01 | 1.686 | 39.29 | | 117.86 | 40 | 97 | 86.1 | 3.0 | 6.0 |
| Example 2-5 | 0 | 0 | 718 | 0 | 2000 | 217.03 | 1.112 | 12.99 | 51.98 | | 21 | 89 | 90.3 | 3.4 | 1.7 |
| Comp. Ex. 2-1 | 0 | 343.43 | 172.23 | 0 | 1200 | 357.47 | 1.838 | | 126.88 | | 40 | 99 | 92 | 1.1 | 13.0 |
| Comp. Ex. 2-2 | 0 | 343.43 | 172.23 | 0 | 1200 | 303.39 | 1.564 | | | 180.95 | 40 | 98 | 88.2 | 3.2 | 14.4 |
| Comp. Ex. 2-3 | 142.03 | 0 | 0 | 331.41 | 1200 | 383.82 | 1.978 | | 142.74 | | 45 | 99 | 52.2 | 35.2 | 40.4 |
| Comp. Ex. 2-4 | 0 | 286.91 | 143.89 | 0 | 1200 | 349.66 | 1.802 | 10.98 | | 208.56 | 50 | 99 | 87.3 | 2.3 | 12.2 |

The materials described in Table 1 are as follows:
Polycarbonate polyol: 1,6-hexanediol polycarbonates having number average molecular weight Mn of 500, 1000, 2000 and 3000
H6XDI: 1,4-bis(isocyanatomethyl)cyclohexane
1,3-PD: 1,3-propanediol
1,4-BD: 1,4-butanediol
1,9-ND: 1,9-nonanediol

Table 2 shows the weight ratio of polyols (A) and that of chain extenders (C), respectively, which has been calculated from the mass of polyols (A) and that of chain extenders (C) in Table 1.

TABLE 2

| | Weight ratio of polyol(s) (A) | | | | Weight ratio of Chain Extender(s) (C) | | |
|---|---|---|---|---|---|---|---|
| | (percent by weight based on sum of (A)) | | | | (percent by weight based on sum of (C)) | | |
| Examples | Mn = 500 | Mn = 1000 | Mn = 2000 | Mn = 3000 | 1,3-PD | 1,4-BD | 1,9-ND |
| Example 1-1 | 80 | 0 | 0 | 20 | 0 | 100 | 0 |
| Example 1-2 | 60 | 0 | 0 | 40 | 0 | 100 | 0 |
| Example 1-3 | 40 | 0 | 0 | 60 | 0 | 100 | 0 |
| Example 1-4 | 30 | 0 | 0 | 70 | 0 | 100 | 0 |
| Example 1-5 | 30 | 0 | 0 | 70 | 0 | 100 | 0 |
| Example 1-6 | 30 | 0 | 0 | 70 | 0 | 100 | 0 |
| Example 1-7 | 20 | 0 | 0 | 80 | 0 | 100 | 0 |
| Example 1-8 | 60 | 0 | 0 | 40 | 20 | 80 | 0 |
| Example 1-9 | 30 | 0 | 0 | 70 | 20 | 80 | 0 |
| Comp. Ex. 1-1 | 100 | 0 | 0 | 0 | 20 | 80 | 0 |
| Comp. Ex. 1-2 | 0 | 0 | 100 | 0 | 0 | 100 | 0 |
| Comp. Ex. 1-3 | 0 | 0 | 0 | 100 | 0 | 100 | 0 |
| Example 2-1 | 0 | 66.6 | 33.4 | 0 | 5 | 0 | 95 |
| Example 2-2 | 0 | 66.6 | 33.4 | 0 | 10 | 0 | 90 |
| Example 2-3 | 0 | 66.6 | 33.4 | 0 | 15 | 0 | 85 |
| Example 2-4 | 0 | 66.6 | 33.4 | 0 | 25 | 0 | 75 |
| Example 2-5 | 0 | 0 | 100 | 0 | 20 | 80 | 0 |
| Comp. Ex. 2-1 | 0 | 66.6 | 33.4 | 0 | 0 | 100 | 0 |
| Comp. Ex. 2-2 | 0 | 66.6 | 33.4 | 0 | 0 | 0 | 100 |
| Comp. Ex. 2-3 | 30 | 0 | 0 | 70 | 0 | 100 | 0 |
| Comp. Ex. 2-4 | 0 | 66.6 | 33.4 | 0 | 5 | 0 | 95 |

As can be seen from Table 1, the TPU composition of the present invention exhibits not only excellent optical properties but also good mechanical property.

It should be appreciated that modifications and alterations of the novel polyurethane and composition described herein may be made, so far as they fall within the scope of the appended claims or the equivalents thereof.

1: A thermoplastic polyurethane obtained from a reaction mixture comprising:
(A) a polycarbonate polyol having a number-average-molecular weight Mn of greater than 500 and less than 2000,
(B) an alicyclic polyisocyanate, and
(C) a chain extender,
wherein the thermoplastic polyurethane has a hard segment (HS) which occupies less than 40 mass %, based on a total mass of the thermoplastic polyurethane.

2: A thermoplastic polyurethane obtained from a reaction mixture comprising:
(A) a polycarbonate polyol having a number-average-molecular weight Mn of greater than 500 and less than 3000,
(B) an alicyclic polyisocyanate, and
(C) at least two kinds of chain extenders,
wherein the thermoplastic polyurethane has a hard segment (HS) which occupies less than 50 mass %, based on a total mass of the thermoplastic polyurethane.

3: The thermoplastic polyurethane according to claim 1, wherein the polycarbonate polyol (A) is a reaction product of a C₂-C₁₆ alkylene diol and a carbonate diester.

4: The thermoplastic polyurethane according to claim 1, wherein the chain extender (C) is at least one selected from the group consisting of 1,2-ethanediol, 1,3-propanediol, 1,4-butanediol, 1,5-pentanediol, 1,6-hexanediol, 1,7-heptanediol, 1,8-octanediol, 1,9-nonanediol, 3-methyl-1,5-pentanediol, 2-methyl-1,8-octanediol, diethylene glycol glycol, and dipropylene glycol.

5: The thermoplastic polyurethane, according to claim 2, wherein the chain extenders (C) comprise a combination of at least two selected from a group consisting of 1,2-ethanediol, 1,3-propanediol, 1,4-butanediol, 1,5-pentanediol, 1,6-hexanediol, 1,7-heptanediol, 1,8-octanediol, 1,9-nonanediol, 3-methyl-1,5-pentanediol, 2-methyl-1,8-octanediol, diethylene glycol, and dipropylene glycol.

6: The thermoplastic polyurethane according to claim 1, wherein a concentration of the alicyclic polyisocyanate (B) is 1.2 to 1.8 mol/kg based on a total mass of the polycarbonate polyol (A), the alicyclic polyisocyanate (B), and the chain extender (C).

7: A polyurethane resin composition comprising:
the thermoplastic polyurethane according to claim 1, and
an antioxidant.

8: A molded product obtained from the polyurethane resin composition according to claim 7.

9: The molded product according to claim 8, wherein the molded product is in the form of a sheet configured to be applied to a substrate for a resin glass.

10: The molded product according to claim 9, wherein the sheet has a thickness of 2 mm and an initial haze value of 5% or less.

11: The thermoplastic polyurethane according to claim 2, wherein the polycarbonate polyol (A) is a reaction product of a C₂-C₁₆ alkylene diol and a carbonate diester.

12: The thermoplastic polyurethane according to claim 2, wherein a concentration of the alicyclic polyisocyanate (B) is 1.2 to 1.8 mol/kg based on a total mass of the polycarbonate polyol (A), the alicyclic polyisocyanate (B), and the chain extenders (C).

13: The thermoplastic polyurethane according to claim 4, wherein a concentration of the alicyclic polyisocyanate (B) is 1.2 to 1.8 mol/kg based on a total mass of the polycarbonate polyol (A), the alicyclic polyisocyanate (B), and the chain extender (C).

14: The thermoplastic polyurethane according to claim 5, wherein a concentration of the alicyclic polyisocyanate (B) is 1.2 to 1.8 mol/kg based on a total mass of the polycarbonate polyol (A), the alicyclic polyisocyanate (B), and the chain extenders (C).

15: A polyurethane resin composition comprising:
the thermoplastic polyurethane according to claim 2, and
an antioxidant.

16: A molded product obtained from the polyurethane resin composition according to claim 15.

17: The molded product according to claim 16, wherein the molded product is in the form of a sheet configured to be applied to a substrate for a resin glass.

18: The molded product according to claim 17, wherein the sheet has a thickness of 2 mm and an initial haze value of 5% or less.
